(19) United States
(12) Patent Application Publication
(10) Pub. No.: US 2019/0371495 A1
(43) Pub. Date: Dec. 5, 2019

(54) PROTECTOR

(71) Applicants: SUMITOMO WIRING SYSTEMS, LTD., Mie-ken (JP); TOYOTA JIDOSHA KABUSHIKI KAISHA, Aichi-ken (JP)

(72) Inventors: Tokuro Suzuki, Yokkaichi-shi (JP); Kazuya Ichigo, Yokkaichi-shi (JP); Yoshihiro Sugiyama, Miyagi (JP)

(73) Assignees: SUMITOMO WIRING SYSTEMS, LTD., Mie-ken (JP); TOYOTA JIDOSHA KABUSHIKI KAISHA, Aichi-ken (JP)

(21) Appl. No.: 16/428,093

(22) Filed: May 31, 2019

(30) Foreign Application Priority Data
Jun. 4, 2018 (JP) 2018-106982

(51) Int. Cl. H01B 7/18; H01B 7/00; B60R 16/02; H01B 7/04

(52) U.S. Cl. CPC H01B 7/185; H01B 7/04; B60R 16/0215; H01B 7/0045

(57) ABSTRACT

A protector includes a main body configured to accommodate a wire harness; and an extension piece that extends from the main body in an extension direction and holds the wire harness with a tape wound around the extension piece and the wire harness, which is drawn out in the extension direction. The extension piece includes an opposed surface that is opposed to the wire harness, and the opposed surface of the extension piece is provided with at least one projection extending in an orthogonal direction that is orthogonal to the extension direction.

### BACKGROUND

### 1. Field

The present disclosure relates to a protector that holds an elongated member such as a wire harness.

### 2. Description of Related Art

Conventionally, an elongated member, such as a wire harness and a bundle of electrical conductive wires, is used with a protector to protect the elongated member and to define the extension directivity of the elongated member when the elongated memberis mounted on a vehicle or electric equipment. The protector includes a main body and an extension piece that extends outward from the main body in an extension direction. The main body of the protector is configured to accommodate the elongated member. The extension piece is configured so that tape is wound around the extension piece and the elongated member that is drawn out from the main body, thereby holding the elongated member that is drawn out from the main body of the protector in a drawing direction that corresponds to the extension direction of the extension piece (for example, refer to Japanese Laid-Open Patent Publication No. 11-275728).

With the conventional protector, the elongated member may be displaced relative to the extension piece in the extension direction of the extension piece.

### SUMMARY

It is an objective of the present disclosure to provide a protector that may restrict displacement of an elongated member relative to an extension piece of the protector in an extension direction of the extension piece.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one aspect of the present disclosure, a protector includes a main body configured to accommodate an elongated member; and an extension piece that extends from the main body in an extension direction and holds the elongated member with a tape wound around the extension piece and the elongated member, which is drawn out in the extension direction, in which the extension piece includes an opposed surface that is opposed to the elongated member, and the opposed surface of the extension piece is provided with at least one protrusion extending in an orthogonal direction that is orthogonal to the extension direction.

With this structure, when the tape is wound around the elongated member and the extension piece, the at least one protrusion extending in the orthogonal direction orthogonal to the extension direction of the extension piece may restrict displacement of the elongated member relative to the extension piece in the extension direction of the extension piece.

In a non-limiting aspect of the present disclosure, the at least one protrusion includes a plurality of protrusions arranged next to each other in the extension direction.

With this structure, the plurality of protrusions arranged next to one another in the extension direction of the extension piece may further restrict displacement of the elongated member relative to the extension piece in the extension direction of the extension piece.

In a non-limiting aspect of the present disclosure, the protector includes a tape restriction portion that further extends from a distal end of the extension piece and is configured to restrict displacement of the tape in the extension direction.

With this structure, the tape restriction portion may restrict displacement of the tape, which is wound around the extension piece, in the extension direction of the extension piece. This may restrict displacement of the elongated member in the extension direction of the extension piece that would result from displacement of the tape.

In a non-limiting aspect of the present disclosure, the opposed surface of the extension piece is provided with at least one inclined protrusion that extends in an inclined direction that is inclined relative to the orthogonal direction.

With this structure, the at least one protrusion and the at least one inclined protrusion on the opposed surface of the extension piece may further restrict displacement of the elongated member relative to the extension piece in the extension direction of the extension piece. This may restrict displacement of the elongated member when the elongated member is pulled, for example, in a diagonal direction relative to the extension direction of the extension piece.

In a non-limiting aspect of the present disclosure, the at least one inclined protrusion includes a first inclined protrusion and a second inclined protrusion that extend in a plurality of different inclined directions.

With this structure, the at least one protrusion, the first inclined protrusion, and the second inclined protrusion on the opposed surface of the extension piece may restrict displacement of the elongated member even when, for example, the elongated member is pulled in any one of a plurality of diagonal directions relative to the extension direction of the extension piece.

The protector according to some aspects of the present disclosure may restrict displacement of the elongated member relative to the extension piece in the extension direction of the extension piece.

Other features and aspects of the present disclosure will be apparent from the following detailed description, the drawings, and the claims.

### BRIEF DESCRIPTION OF THE DRAWINGS

FIG. 1 is a perspective view showing a protector according to one embodiment.

FIG. 2 is a side view showing the protector according to one embodiment.

FIG. 3 is an enlarged view showing an extension piece of the protector according to one embodiment.

FIG. 4 is an enlarged view showing an extension piece of an protector according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

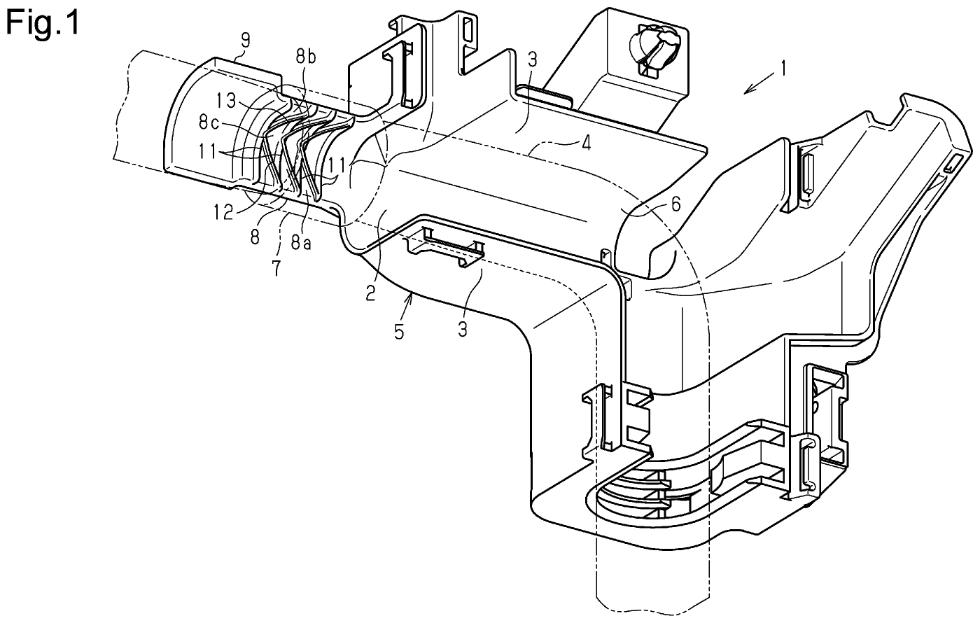

One embodiment of a protector will hereinafter be described with reference to FIGS. 1 to 3.

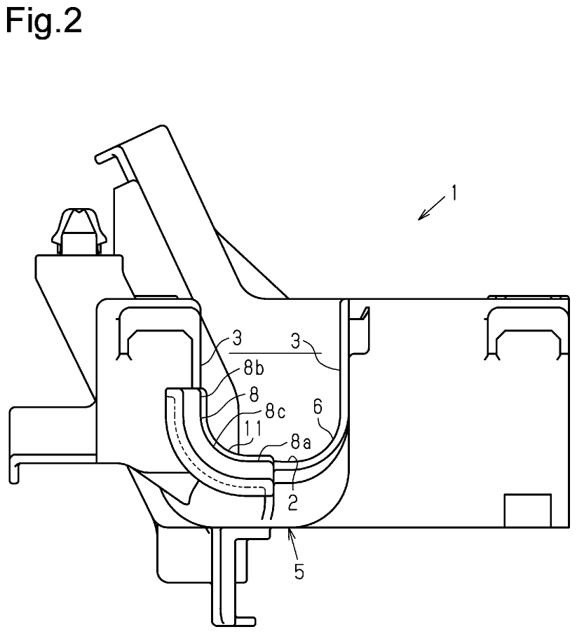

As shown in FIGS. 1 and 2, a protector 1 includes a main body 5 configured to accommodate a wire harness 4 (see FIG. 1) serving as an elongated member. In a non-limiting example, the main body 5 is L-shaped in a plan view and includes two ends from which the wire harness 4 is drawn out and a bent portion between the two ends of the main body 5. In the illustrated example, the main body 5 includes a bottom plate 2 and two side plates 3 extending from the two widthwise ends of the bottom plate 2. The bottom plate 2 and the side plates 3 are connected by curved portions 6. In the specification, the portion of the wire harness 4 accommodated in the main body 5 may be referred to as a first length portion of the wire harness 4.

The protector 1 includes an extension piece 8 extending from the main body 5 in extension direction Dl. The extension piece 8 of the protector 1 is configured to hold the wire harness 4 with a tape 7 wound around the extension piece 8 and the wire harness 4, which is drawn out in the extension direction D1.

In the illustrated example, the extension piece 8 extends from an outlet formed in one end of the main body 5 from which the wire harness 4 is drawn out. The extension piece 8 may have a predetermined extension length in the extension direction D1. In the specification, the extension piece 8 may be referred to as a guide extension that guides the wire harness 4 from the outlet of the main body 5 in the extension direction D1. The extension piece 8 includes an opposed surface that opposes and/or contacts the outer circumferential surface of the wire harness 4. The opposed surface of the extension piece 8 may be referred to as a guide surface or a first surface that guides the wire harness 4 in the extension direction D1. The extension piece 8 includes a non-opposed surface that is on the opposite side of the opposed surface of the extension piece 8 and that is not opposed to the outer circumferential surface of the wire harness 4. The non-opposed surface may be referred to as a non-guide surface or a second surface of the extension piece 8. In a non-limiting example, the opposed surface of the extension piece 8 is an inner or concave surface of the extension piece 8 and the non-guide surface of the extension piece 8 is an outer or convex surface of the extension piece 8.

The extension piece 8 may include a bottom piece 8a formed to extend from the bottom plate 2, a side piece 8b formed to extend from one of the side plates 3, and a curved piece 8c formed to extend from the curved portion 6.

The tape 7 may be an adhesive tape having an adhesive surface. The tape 7 is wound with the adhesive surface of the tape 7 in contact with the outer surface of the extension piece 8, which is the non-opposed surface of the extension piece 8 that is not opposed to the wire harness 4.

In a non-limiting example, the extension piece 8 is configured to cover only a first side surface portion of the wire harness 4 in the circumferential direction. The first side surface portion is part of the outer circumferential surface of a second length portion of the wire harness 4 in the circumferential direction, and the second length portion is different from or ajacent to the first length portion of the wire harness 4 accommodated in the main body 5. A second side surface portion of the second length portion of the wire harness 4 excluding the first side surface portion is not covered by and exposed from the extension piece 8. The tape 7 is in continuous contact with and/or adrered to the non-opposed surface of the extension piece 8 and the second side surface portion of the second length portion of the wire harness 4 that is adjacent to the non-opposed surface of the extension piece 8 in the circumferential direction.

The protector I may include a tape restriction portion 9 that further extends from a distal end of the extension piece 8 and restricts displacement of the tape 7, which is wound around the extension piece 8, in the extension direction D1. In the illustrated embodiment, the tape restriction portion 9 is bulged outward from the extension piece 8 in the radial direction of the wire harness 4 so that a step is formed in the radial direction of the wire harness 4 between the extension piece 8 and the tape restriction portion 9. The step in the radial direction restricts or prevents displacement of the tape 7 in the extension direction D1 from the extension piece 8 toward the tape restriction portion 9.

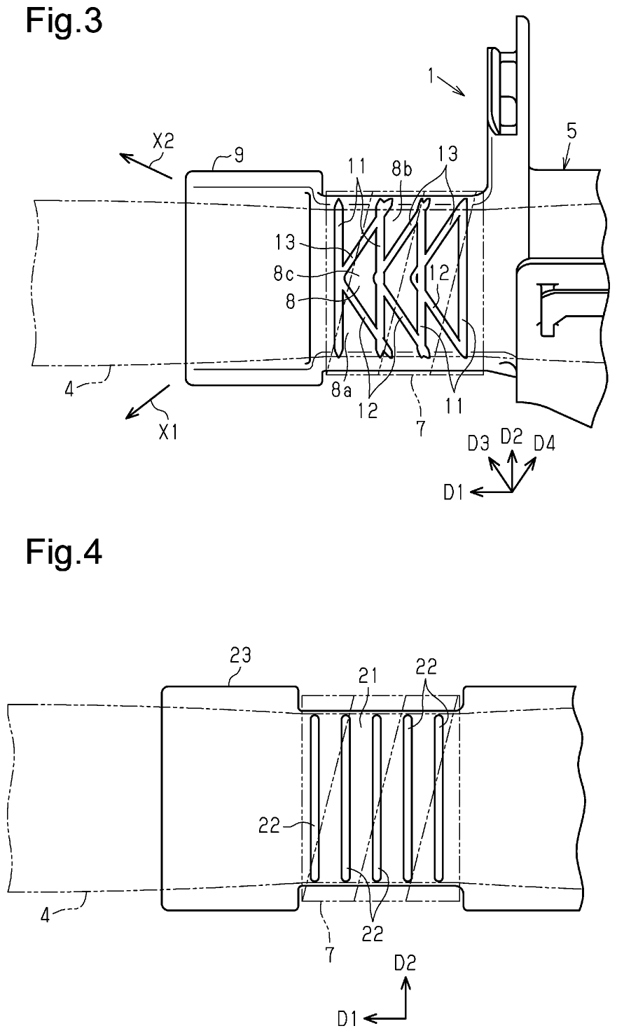

As shown in FIG. 3, the opposed surface of the extension piece 8 in the present embodiment is provided with at least one protrusion 11 extending in direction D2 that is orthogonal to the extension direction D1 of the extension piece 8. In the specification, the direction D2 may be referred to as orthogonal direction.

In the illustrated example, a plurality of (four in the present embodiment) protrusions 11 are arranged next to one another in the extension direction D1. The protrusions 11 are each formed as elongated protrusions (ribs) that are continuous from one end of the bottom piece 8a to one end of the side piece 8b, more specifically, from one end to the other end of the opposed surface of the extension piece 8 opposed to the wire harness 4. The protrusions 11 each may protrude from the opposed surface of the extension piece 8 in a radially inward direction toward the outer circumferential surface of the wire harness 4 with a projection height.

In the present embodiment, the opposed surface of the extension piece 8 opposed to the wire harness 4 is provided with first inclined protrusions 12 and second inclined protrusions 13, which serves as inclined protrusion extending in directions inclined relative to the direction in which the protrusions 11 extend (i.e., orthogonal direction D2). The first inclined protrusions 12 and the second inclined protrusions 13 extend in different inclined directions D3 and D4. Specifically, the first inclined protrusions 12 each extend in the inclined direction D3 from the end of the bottom piece 8a to the central portion of the curved piece 8c. The first inclined protrusions 12 each approach the distal end of the extension piece 8 as the central portion of the curved piece 8c becomes closer. The second inclined protrusions 13 each extend in the inclined direction D4 from the end of the side piece 8b to the central portion of the curved piece 8c. The second inclined protrusions 13 each approach the distal end of the extension piece 8 as the central portion of the curved piece 8c becomes closer. A plurality of (three in the present embodiment) first inclined protrusions 12 are arranged next to one another in the extension direction D1, and a plurality of (three in the present embodiment) second inclined protrusions 13 are arranged next to one another in the extension direction D1. The first inclined protrusions 12 and the second inclined protrusions 13 are each partially continuous with the protrusions 11. In the embodiment of FIG. 3, each of the first inclined protrusions 12 connects two adjacent protrusions 11, and each of the second inclined protrusions 13 connects two adjacent protrusions 11.

The operations of the protector 1 will now be described.

The wire harness 4 is accommodated in the main body 5 of the protector 1. In this state, the tape 7 is wound around the extension piece 8 together with the wire harness 4, so that the wire harness 4, which is drawn out in the extension direction D1 of the extension piece 8, is fixedly held on the extension piece 8. In this state, the protrusions 11, the first inclined protrusions 12, and the second inclined protrusions 13 of the extension piece 8 are in direct contact with the wire harness 4.

Advantages of the above embodiment will now be described.

(1) The opposed surface of the extension piece 8 opposed to the wire harness 4 is provided with the protrusions 11 extending in the orthogonal direction D2, which is orthogonal to the extension direction D1. This restricts displacement of the wire harness 4 in the extension direction D1 relative to the extension piece 8 in a state in which the tape 7 is wound around the extension piece 8 together with the wire harness 4. Thus, the number of winding of the tape 7 may be reduced. The wire harness 4 can be held relative to the extension piece 8 at a desired position in the extension direction D1 without, for example, using a special tape. This holds the wire harness 4 at the designed position relative to the extension piece 8.

(2) The plurality of (four in the present embodiment) protrusions 11 are arranged in the extension direction D1. This further restricts displacement of the wire harness 4 in the extension direction D1 relative to the extension piece 8.

(3) The tape restriction portion 9, which further extends from the distal end of the extension piece 8, restricts displacement of the wound tape 7 in the extension direction D1. This further restricts displacement of the wire harness 4 in the extension direction D1 that would be caused by displacement of the tape 7 in the extension direction Dl.

(4) The opposed surface of the extension piece 8 opposed to the wire harness 4 is provided with the first inclined protrusions 12 and the second inclined protrusions 13, which serve as inclined protrusions extending in directions inclined relative to the direction in which the protrusions 11 extend. This further restricts displacement of the wire harness 4 in the extension direction D1 relative to the extension piece 8 and displacement of the wire harness 4 when the wire harness 4 is pulled, for example, in a diagonal direction.

(5) The first inclined protrusions 12 and the second inclined protrusions 13 extend in different inclined directions. This further restricts displacement of the wire harness 4 when the wire harness 4 is pulled, for example, in a number of diagonal directions. Specifically, as shown in FIG. 3, when the wire harness 4, which extends out of the distal end of the extension piece 8, is pulled, for example, in diagonal direction X1 toward the bottom piece 8a, the first inclined protrusions 12 mainly act to restrict displacement of the wire harness 4. When the wire harness 4 is pulled in diagonal direction X2 relative to the side piece 8b, the second inclined protrusions 13 mainly act to restrict displacement of the wire harness 4.

The present embodiment may be modified as described below. The present embodiment and modifications below may be implemented in combination as long as there are no technical contradictions.

In the above embodiment, the opposed surface of the extension piece 8, which is opposed to the wire harness 4, is provided with inclined protrusions (such as the first inclined protrusions 12 and the second inclined protrusions 13) extending in directions inclined relative to the direction in which the protrusions 11 extend. However, the inclined protrusions 12, 13 may be omitted.

For example, in a modification shown in FIG. 4, the opposed surface of an extension piece 21 opposed to the wire harness 4 is provided with only protrusions 22 extending in the orthogonal direction D2, which is orthogonal to the extension direction D1. In the modification shown in FIG. 4, five protrusions 22 are arranged next to one another in the extension direction D1. The extension piece 21 may be a substantially flat plate, and the opposed surface of the extension piece 21 opposed to the wire harness 4 may be flat. A tape restriction portion 23 further extends in the extension direction D1 from the distal end of the extension piece 21 of the modification to restrict displacement of the wound tape 7. The extension piece 21 has a first width in the orthogonal direction D2, and the tape restriction portion 23 has a second width, which is greater than the first width, in the orthogonal direction D2. A step is formed in the width direction between the extension piece 21 and the tape restriction portion 23. The step in the width direction restricts or prevents displacement of the tape 7 in the extension direction D1 from the extension piece 21 to the tape restriction portion 23.

This obtains advantages (1) to (3) of the above embodiment.

In the above embodiment and modification, the plurality of (four in the embodiment and five in modification) protrusions 11 and 22 are arranged next to one another. The numbers of the protrusions 11 and 22 may be changed so that there is, for example, only one. The protrusions 11 or 22 may each be formed as a plurality of sub-protrusions or divided protrusions lined in direction D2, which is orthogonal to the extension direction D1 of the extension piece 8 or 21 as long as the protrusions 11 or 22 have a height and extend in direction D2, which is orthogonal to the extension direction D1 of the extension piece 8 or 21.

The tape restriction portions 9 and 23 in the above embodiment and modifications may have other shapes as long as the tape restriction portions 9 and 23 restrict displacement of the wound tape 7 in the extension direction D1. The tape restriction portions 9 and 23 may be omitted.

In the above embodiment, the inclined protrusions include the first inclined protrusions 12 and the second inclined protrusions 13 extending in different directions but may include only either one of the inclined protrusions. Further, an inclined protrusion (third inclined protrusion, fourth inclined protrusion, or the like) that extends in a direction differing from the first inclined protrusion 12 and the second inclined protrusion 13 may be added.

In the above embodiment, the wire harness 4 is described as a representative example of an elongated member. However, the elongated member may be a single elongated electrical conductor element such as a single power feeding line or a single signal line. Alternatively, the elongated member may be a bundle of a plurality of elongated electrical conductor elements such as a bundle of power feeding lines, a bundle of signal lines, or a combination of power feeding line(s) and signal line(s). The elongated member may include a corrugated tube that covers a single elongated electrical conductor element or a bundle of a plurality of elongated electrical conductor elements. The elongated electrical conductor element may be a bare electric wire or a sheathed electric wire that includes an electrical conductor core and an insulating coating layer covering the electrical conductor core.

The present disclosure encompasses the following implementations. Some reference numerals of typical elements in the illustrated embodiment are given to facilitate understanding in a non-limiting manner.

[Implementation 1] A protector (1) according to one implementation includes a protector body (5) configured to accommodate a first length portion of an elongated member (4) indluding electrical conductor element(s); and

a guide extension (8) extending from the protector body (5) in an extension direction (D1), in which

the guide extension (8) is configured to guide a second length portion of the elongated electrical conductor element (4),which is different from the first length portion, in the extension direction (D1) with a tape (7) wound around the guide extension (8), and

the guide extension (8) includes a guide surface that is opposed to the second length portion of the elongated electrical conductor element (4) and at least one protrusion (11), in which the at least one protrusion (11) has a height and protrudes from the guide surface of the guide extension (8) and has a length and extends in an orthogonal direction (D2) that is orthogonal to the extension direction (D1).

[Implementation 2] The at least one protrusion (11) of the protector (1) may include a plurality of protrusions (11) arranged next to each other in the extension direction (D1).

[Implementation 3] The protector (1) may include a tape displacement restriction projection (9) that further extends from a distal end of the guide extension (8) in the extension direction (D1), in which a step that restricts displacement of the tape (7) in the extension direction (D1) is formed between the tape displacement restriction projection (9) and the guide extension (8).

[Implementation 4] The guide surface of the guide extension (8) may be provided with at least one protrusion (12, 13) that has a length and extends in an inclined direction (D3 or D4) that is inclined relative to the orthogonal direction (D2). The at least one protrusion (12, 13) may have a height from the guide surface of the guide extension (8).

[Implementation 5] The at least one inclined protrusion (12, 13) includes a first inclined protrusion (12) and a second inclined protrusion (13) that have a length and extend in a plurality of different directions (D3, D4).

[Implementation 6] The guide extension (8) may be a curved plate or a flat plate, whiand may be substantially inflexible.

[Implementation 7] The protector (1) may be a one-piece component, and may be formed of a synthetic resin, such as electrical insulating resin.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A protector comprising:
a main body configured to accommodate an elongated member; and
an extension piece that extends from the main body in an extension direction and holds the elongated member with a tape wound around the extension piece and the elongated member, which is drawn out in the extension direction,
wherein the extension piece includes an opposed surface that is opposed to the elongated member, and the opposed surface of the extension piece is provided with at least one protrusion extending in an orthogonal direction that is orthogonal to the extension direction of the extension piece.

2. The protector according to claim 1, wherein the at least one projection includes a plurality of projections arranged next to each other in the extension direction.

3. The protector according to claim 1, comprising a tape restriction portion that further extends from a distal end of the extension piece and restricts displacement of the tape in the extension direction.

4. The protector according to claim 1, wherein the opposed surface of the extension piece is provided with at least one inclined projection that extends in an inclined direction that is inclined relative to the orthogonal direction.

5. The protector according to claim 4, wherein the at least one inclined projection includes a first inclined projection and a second inclined projection that extend in a plurality of different inclined directions.
